(19) United States
(12) Patent Application Publication
(10) Pub. No.: US 2018/0052298 A1
(43) Pub. Date: Feb. 22, 2018

(54) LENS DRIVING APPARATUS

(71) Applicant: OLYMPUS CORPORATION, Tokyo (JP)

(72) Inventor: Yoshiaki SUEOKA, Hachioji-shi (JP)

(73) Assignee: OLYMPUS CORPORATION, Tokyo (JP)

(21) Appl. No.: 15/796,416

(22) Filed: Oct. 27, 2017

Related U.S. Application Data
(63) Continuation of application No. PCT/JP2015/084548, filed on Dec. 9, 2015.

(30) Foreign Application Priority Data
Jun. 9, 2015 (JP) 2015-116850

(51) Int. Cl. G02B 7/04; G03B 13/34

(52) U.S. Cl. CPC G02B 7/04; G03B 13/34

(57) ABSTRACT

A lens driving apparatus includes a holding mechanism that holds a movable frame holding a lens at a position close to a reference position. A controller controls a first driving unit and a second driving unit so that the movable frame is held at the reference position when the power is turned off.

### CROSS-REFERENCE TO RELATED APPLICATIONS

This application is a Continuation Application of PCT Application No. PCT/JP2015/084548, filed Dec. 9, 2015 and based upon and claiming the benefit of priority from Japanese Patent Application No. 2015-116850, filed Jun. 9, 2015, the entire contents of all of which are incorporated herein by reference.

### FIELD

The present invention relates generally to a lens driving apparatus that drives a focus lens of a camera in an optical axis direction.

### BACKGROUND

For example, lens driving apparatuses that drive a focus lens of a camera in an optical axis direction include a movable frame that holds a lens, a lens barrel that slidably houses the movable frame, and a Voice Coil Motor (VCM) that moves the movable frame in the optical axis direction relative to the lens barrel. The VCM includes a coil that is fixed to one of the movable frame and the lens barrel (stationary frame), and a magnet that is fixed to another one of the movable frame and the lens barrel.

The movable frame is moved in the optical axis direction relative to the lens barrel by an electromagnetic induction with the magnet by energizing the coil.

In the aforementioned conventional lens driving apparatuses, the movable frame is freely movable relative to the lens barrel when the coil of VCM is not energized. Accordingly, if the power is turned on to move the movable frame to a desired position in the optical axis direction, the movable frame is returned to a home position once to set a reference position for control, and is thereafter moved to the desired position from the home position.

Thus, it takes a long time to move the movable frame to the desired position when the apparatus is powered on, which is inconvenient.

### SUMMARY

The present invention has been made in view of the above, and an object of the present invention is to provide a lens driving apparatus that is capable of moving a lens to a desired position in a short time from startup, with a simple structure.

According to one aspect of the invention, a lens driving apparatus including: a lens holder configured to hold a lens; a guide member configured to guide movement of the lens holder in an optical axis direction; a stationary member configured to hold the guide member; a first driving unit including a magnet placed at one of the lens holder and the stationary member, and a coil placed at another one of the lens holder and the stationary member, and configured to move the lens holder in the optical axis direction along the guide member by a propulsion force generated by energizing the coil; a reference position detector configured to detect a reference position of the lens holder; a driving position output unit configured to output a driving position of the lens holder relative to the reference position after the reference position of the lens holder is set based on an output of the reference position detector; and a locking unit configured, if a signal indicating a power shutdown or a sleep state is output, to direct the first driving unit to move the lens holder to the reference position based on outputs of the reference position detector and the driving position output unit, to hold the lens holder to the stationary member in synchronism with an output from the reference position detector, and to lock movement of the lens holder.

According to the present invention, it is possible to provide a lens driving apparatus that is capable of moving a lens to a desired position in a short time from startup, with a simple structure.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view of a camera including a lens driving apparatus according to an embodiment.

FIG. 2 is a block diagram showing a control system of the lens driving apparatus shown in FIG. 1.

FIG. 3 is a cross-sectional view of the lens driving apparatus shown in FIG. 1 in the direction orthogonal to an optical axis.

FIG. 4 is a cross-sectional view taken along line F4-F4 in FIG. 3.

FIG. 5 is a cross-sectional view taken along line F5-F5 in FIG. 3.

FIG. 6 is a cross-sectional view of the state where the movable portion shown in FIG. 3 is held.

FIG. 7 is a cross-sectional view taken along line F7-F7 in FIG. 6.

FIG. 8 is a cross-sectional view taken along line F8-F8 in FIG. 6.

FIG. 9 is a flowchart illustrating the control operation when the lens driving apparatus shown in FIG. 1 is powered off.

FIG. 10 is a flowchart illustrating the control operation when the lens driving apparatus shown in FIG. 1 is powered on.

FIG. 11 is a flowchart illustrating a modification of the control operation when the lens driving apparatus shown in FIG. 1 is powered on.

FIG. 12 is a graph showing an example of a detection signal by a reference sensor of the lens driving apparatus shown in FIG. 1.

### DETAILED DESCRIPTION

Hereinafter, an embodiment of the present invention will be described with reference to the drawings.

In the drawings used for the following descriptions, the scale of each structural element may be different in order to be recognized in the drawings. The present invention is not limited to the number, shapes, ratio of sizes, and relative positions of structural elements shown in the drawings.

In the following descriptions, the direction from a camera main body 200 to a subject (not shown in the drawings) is referred to as “front”, and the opposite direction is referred to as “rear” or “back”. An axis corresponding to the optical axis O of a photographing optical system formed by a lens unit 100 is referred to as a Z axis, and two axes orthogonal to one another on the plane orthogonal to the Z axis are respectively referred to as an X axis and a Y axis.

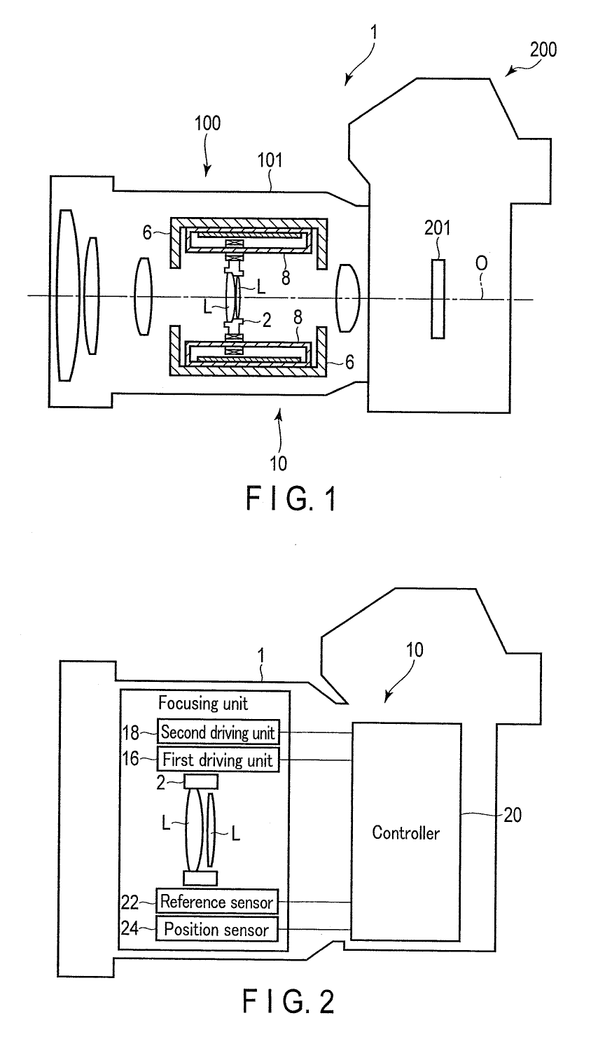

FIG. 1 is a schematic view of a camera 1 in which the lens unit 100 is attached in front of the camera main body 200. The lens unit 100 includes a lens driving apparatus 10 that moves a lens L in the Z axis direction along the optical axis O. The lens L is a lens among of a plurality of lenses of the photographing optical system that contributes to focusing.

FIG. 2 is a block diagram of a control system that controls an operation of the lens driving apparatus 10. A controller 20 controls the lens driving apparatus 10 to form an image of a subject not shown in the drawings on an imaging element 201 (FIG. 1).

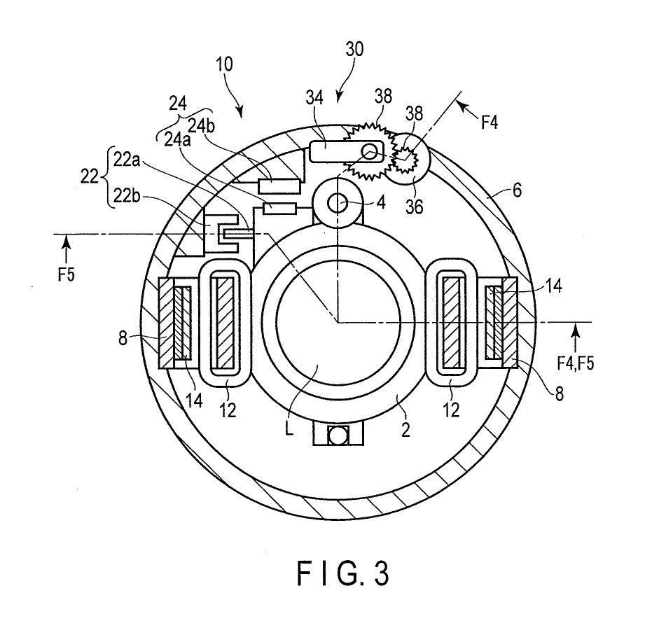

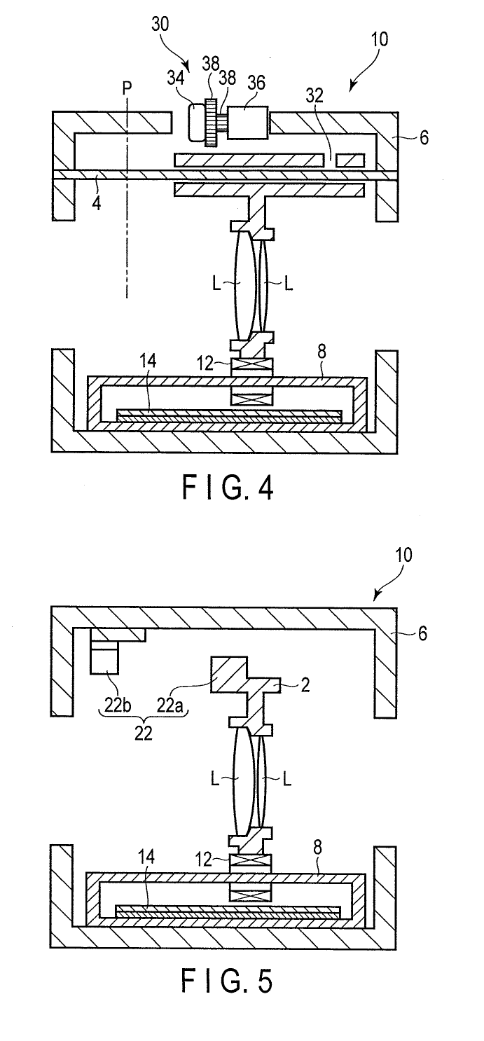

FIG. 3 is a cross-sectional view of a main part of the lens driving apparatus 10, taken along a plane (XY plane) orthogonal to the optical axis O. FIG. 4 is a cross-sectional view of the structure shown in FIG. 3, taken along line F4-F4, and FIG. 5 is a cross-sectional view of the structure shown in FIG. 3, taken along line F5-F5.

The lens driving apparatus 10 includes a movable frame 2 (lens holder) that holds the lens L, a guide member 4 that guides movement of the movable frame 2 in the optical axis O direction, a stationary frame 6 (stationary member) that holds the guide member 4, and two sets of yokes 8. The stationary frame 6 is fixed to a lens barrel 101 (FIG. 1) of the lens unit 100. The two sets of yokes 8 are fixed to the stationary frame 6 at both sides of the lens L.

The lens driving apparatus 10 includes a coil 12 arranged in the movable frame 2, and a magnet 14 arranged in the stationary frame 6. The coil 12 and the magnet 14 are provided to each of the two sets of yokes 8. In contrast to the present embodiment, the magnet 14 may be arranged in the movable frame 2, and the coil 12 may be arranged in the stationary frame 6.

A pair of the coil 12 and the magnet 14 forms a first driving unit 16 (FIG. 2) along with one of the yokes 8. The first driving unit 16 is a Voice Coil Motor (VCM) that moves the movable frame 2 in the optical axis O direction relative to the stationary frame 6, along the guide member 4 by a propulsion force generated by energizing the coil 12.

The lens driving apparatus 10 also includes a reference sensor 22 (reference position detector) that detects a reference position of the movable frame 2 along the optical axis O direction, and a position sensor 24 (driving position output unit) that outputs a driving position of the movable frame 2 relative to the reference position after the reference position of the movable frame 2 is set based on an output of the reference sensor 22. In the present embodiment, the reference position of the movable frame 2 corresponds to an infinity focus position of the photographing optical system.

In the present embodiment, the reference sensor 22 is a photo-interrupter that includes a detection-object piece 22a provided in the movable frame 2 and a detector 22b provided in the stationary frame 6, and the position sensor 24 is a Giant Magneto Resistance (GMR) sensor that includes a magnetic scale 24a provided in the movable frame 2 and a detector 24b provided in the stationary frame 6.

The detection-object piece 22a of the photo-interrupter moves in the optical axis O direction along with the movable frame 2. The detector 22b has a light emitting element and a light receiving element (not shown in the drawings) positioned opposite to each other relative to a moving path of the detection-object piece 22a. A state where the light receiving element receives an optical beam emitted from the light emitting element is referred to as a sensor output, “bright”, and a state where the detection-object piece 22a blocks the optical axis is referred to as a sensor output, “dark”.

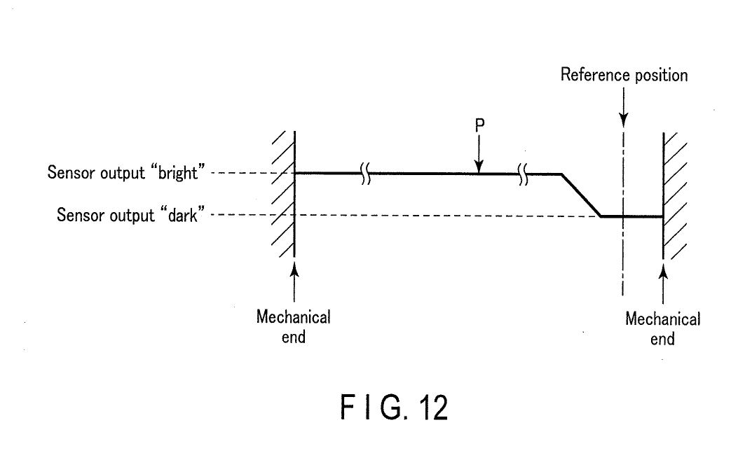

FIG. 12 illustrates an example of a detection signal by the detector 22b of the photo-interrupter. The detector 22b (the light emitting element and the light receiving element) is provided in the stationary frame 6 close to one of terminal portions (a mechanical end of the right side in the drawings) of a moving range of the movable frame 2. Accordingly, the movable frame 2 reaches one of the mechanical ends while the sensor output is maintained to be “dark”, in which the detection-object piece 22a is detected. In this case, the reference position is set to be a position of the detection-object piece 22a where the optical axis of the detector 22b crosses the center of the direction of movement of the detection-object piece 22a.

The magnetic scale 24a has a structure where a north pole and a south pole are arranged at an equal distance in the optical axis O direction, and the detector 24b detects a flux of the magnetic scale 24a. The controller 20 calculates a moving amount from the reference position of the movable frame 2 based on a changing amount of flux detected by the detector 24b.

The lens driving apparatus 10 includes a holding mechanism 30 (locking unit) that allows the first driving unit 16 to move the movable frame 2 to the reference position based on the outputs of the reference sensor 22 and the position sensor 24, and locks movement of the movable frame 2 relative to the stationary frame 6 by holding the movable frame 2 to the stationary frame 6 in synchronism with an output from the reference sensor 22, in a case where a signal indicating a power shutdown or a sleep state is output. A second driving unit 18 drives the holding mechanism 30.

The holding mechanism 30 includes an engagement recess 32 provided in the movable frame 2 and an engagement piece 34 (restriction member) provided in the stationary frame 6. The second driving unit 18 (FIG. 2) includes a step motor 36, and gear array 38 that conveys rotation of the step motor 36 to the engagement piece 34. The second driving unit 18 moves the engagement piece 34 between a position where the engagement piece 34 is engaged with the engagement recess 32 and a position where the engagement piece 34 is removed from the engagement recess 32 (the engagement is released). If the engagement piece 34 is engaged with (abutted on) the engagement recess 32, the movement of the movable frame 2 is locked relative to the stationary frame 6 along the optical axis O direction. The engagement recess 32 is provided at a position where the movable frame 2 is allowed to be placed close to the reference position (position P described below), while being engaged with the engagement piece 34.

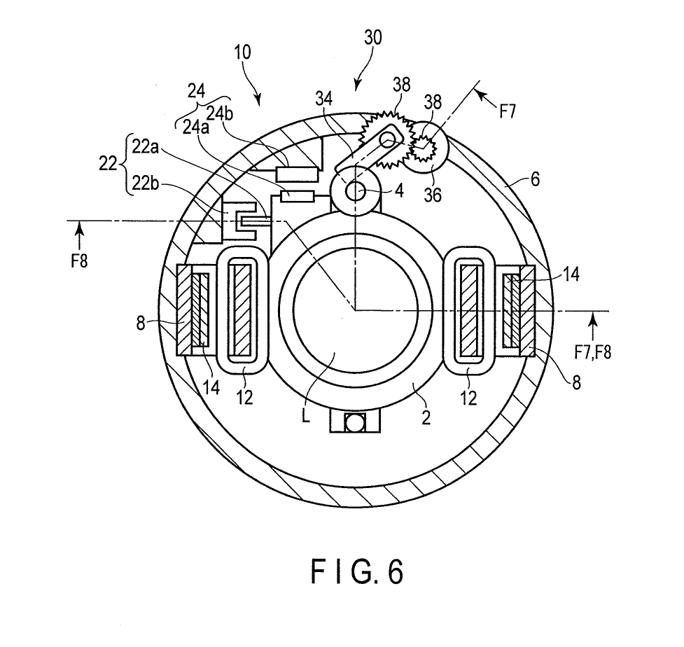

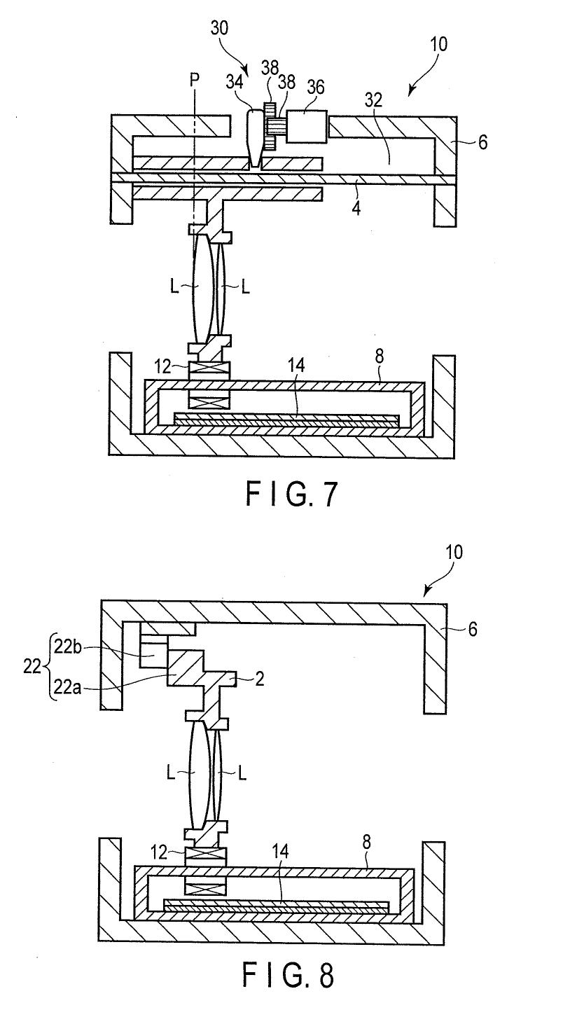

The operation of the aforementioned lens driving apparatus 10 will be described with reference to FIGS. 3-10. FIGS. 3-5 show the state where the movable frame 2 is freely movable in the optical axis O direction (unheld state), and FIGS. 6-8 show the state where the movable frame 2 is held at a holding position P close to the reference position (held state). The holding position P is a position separate from the reference position by a predetermined distance in a predetermined direction (the left direction in FIG. 12), and is set to be a position separate from the reference position by 10% or less of the total length of the moving path of the movable frame 2 in the present embodiment.

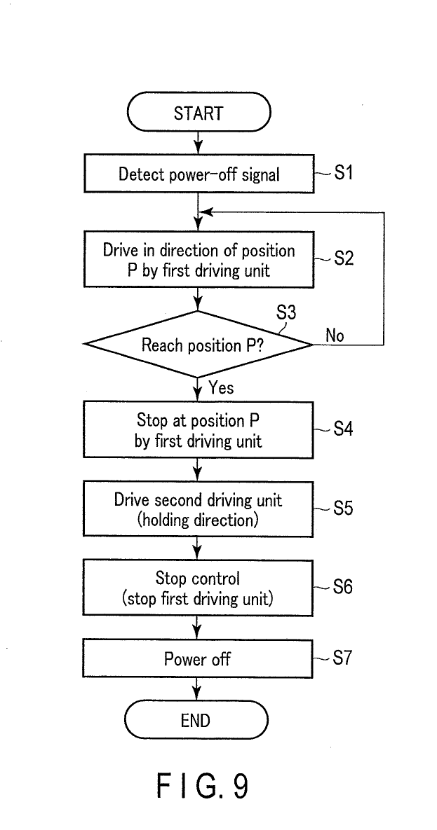

FIG. 9 is a flowchart illustrating the control operation when the power is turned off.

In a case where a signal indicating a power shutdown or a sleep state is output, if the controller 20 detects a power-off signal (step 1), the controller 20 controls the first driving unit 16 to drive the movable frame 2 in the direction of the holding position P (step 2). If it is determined that the movable frame 2 reaches the holding position P (step 3: Yes), the controller 20 controls the first driving unit 16 to stop the movable frame 2 at the holding position P (step 4).

Then, the controller 20 controls the second driving unit 18 so that the engagement piece 34 of the holding mechanism 30 is engaged with the engagement recess 32 (step 5). By this operation, the movable frame 2 is held at the holding position P. Thereafter, the controller 20 stops the operation of the first driving unit 16 (power feeding to the coil 12) (step 6), and turns the power off (step 7).

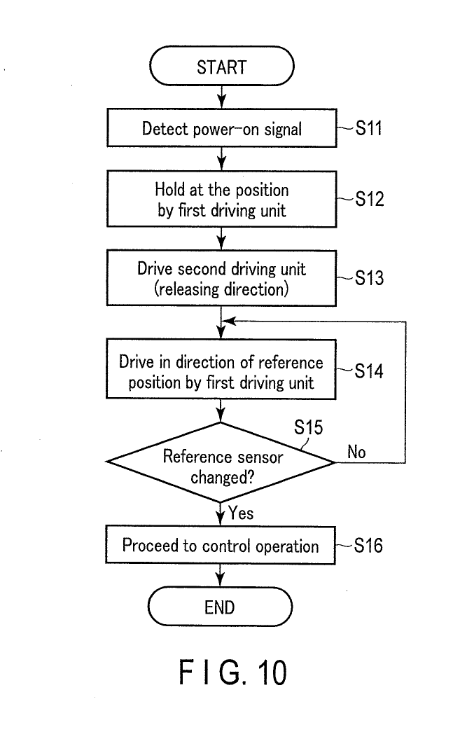

FIG. 10 is a flowchart illustrating the control operation when the power is turned on.

If a power-on signal is detected (step 11), the controller 20 activates the first driving unit 16 to hold the movable frame 2 at the holding position P (step 12). In this state, the controller 20 controls the second driving unit 18 so that the engagement between the engagement piece 34 and the engagement recess 32 is released (step 13). In this state, the movable frame 2 is held at the holding position P.

Thereafter, the controller 20 controls the first driving unit 16 to move the movable frame 2 toward the reference position (step 14). If it is determined that the movable frame 2 reaches the reference position, and the reference sensor 22 is switched (step 15: Yes), the controller 20 proceeds with the normal control operation (step 16).

As stated above, according to the present embodiment, since the movable frame 2 is held at the holding position P close to the reference position when the power is turned off, the movable frame 2 can be moved to the reference position instantly when the power is turned on, and the normal control operation can be initiated immediately after the power is turned on. Accordingly, the present embodiment improves convenience.

In the present embodiment, the movable frame 2 is held at the holding position P close to the reference position when the power is turned off; however, the holding position P is not necessary to be close to the reference position. That is, according to the present embodiment, the movable frame 2 is at least held at the holding position P away from the reference position in a predetermined direction

(the left direction of FIG. 12 in the present embodiment) when the power is turned off so that the direction to which the movable frame 2 is to be moved can be determined when the power is turned on. Accordingly, it is possible to eliminate an unnecessary control operation in that the movable frame 2 is moved to a direction opposite to the direction toward the reference position.

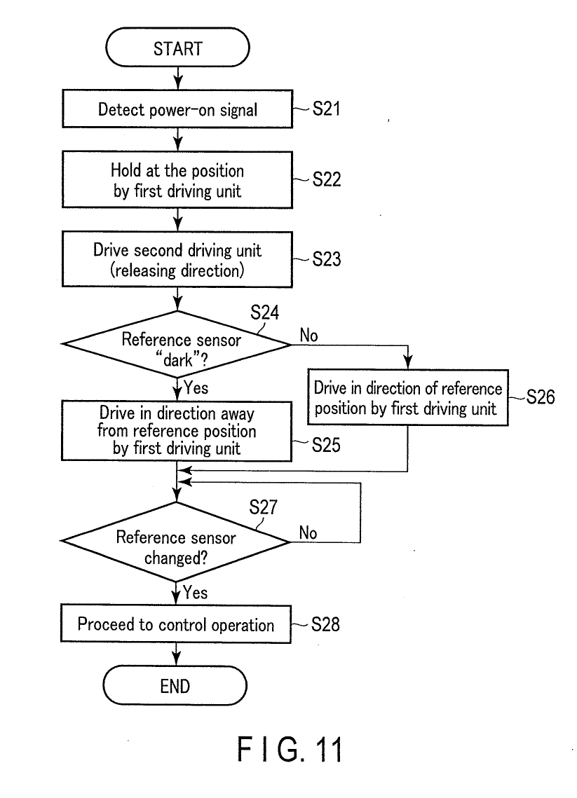

FIG. 11 is a flowchart illustrating the modification of the control operation when the power is turned on. In the aforementioned embodiment, the movable frame 2 is held at the holding position P close to the reference position when the power is turned off; however, in the modification, the movable frame 2 is held at the reference position when the power is turned off. As stated above, the reference position is set to be close to one of the mechanical ends within the moving range of the movable frame 2. Accordingly, in the state where the movable frame 2 is placed at the reference position, the sensor output of the reference sensor 22 is normally “dark”.

If a power-on signal is detected (step 21), the controller 20 activates the first driving unit 16 to hold the movable frame 2 at a position P (step 22). In this state, the controller 20 controls the second driving unit 18 so that the engagement between the engagement piece 34 and the engagement recess 32 is released (step 23). In this state, the movable frame 2 is held at the reference position.

Thereafter, the controller 20 checks the state of the reference sensor 22 (sensor output), and if the output of the reference sensor 22 is “dark” (step 24: Yes), the controller 20 determines that the movable frame 2 is placed at the reference position, and controls the first driving unit 16 to move the movable frame 2 away from the reference position (the left direction in FIG. 12) (step 25).

On the other hand, if it is detected that the output of the reference sensor 22 is “bright” at step 24 (step 24: No), the controller 20 determines that the movable frame 2 is not placed at the reference position, and controls the first driving unit 16 to move the movable frame 2 toward the reference position (the right direction in FIG. 12) (step 26).

In either case, if it is determined that the movable frame 2 reaches the reference position (or is moved from the reference position), and the reference sensor 22 is switched (step 27: Yes), the controller 20 proceeds with the normal control operation (step 28).

As stated above, according to the present modification, since the movable frame 2 is held at the reference position when the power is turned off, the control operation can be initiated rapidly in comparison with the aforementioned embodiment, thereby improving convenience. In addition, according to the modification, even if the movable frame 2 is not placed at the reference position when the power is turned on, the movable frame 2 can be moved instantly to the reference position, and the normal control operation can proceed instantly.

The present invention is not limited to the embodiment described above and can be modified in various manners without departing from the spirit of the invention.

1-7. (canceled)

8. A lens driving apparatus comprising:
a lens holder configured to hold a lens;
a guide member configured to guide movement of the lens holder in an optical axis direction;
a stationary member configured to hold the guide member;
a first driving unit including a magnet placed at one of the lens holder and the stationary member, and a coil placed at another one of the lens holder and the stationary member, and configured to move the lens holder in the optical axis direction along the guide member by a propulsion force generated by energizing the coil;
a reference position detector configured to detect a reference position of the lens holder;
a driving position output unit configured to output a driving position of the lens holder relative to the reference position after the reference position of the lens holder is set based on an output of the reference position detector; and
a locking unit configured, if a signal indicating a power shutdown or a sleep state is output, to hold the lens holder to the stationary member and to lock movement of the lens holder,
wherein a position where the locking unit locks the lens holder is a position where the lens holder is moved by the first driving unit based on outputs of the reference position detector and the driving position output unit, and which is away from the reference position by 10% or less of a total length of a moving path of the lens holder.

9. The lens driving apparatus according to claim 8, wherein the locking unit is provided in the stationary member and is a restriction member that abuts on the lens holder.

10. The lens driving apparatus according to claim 8, wherein the lens is a lens that contributes to focusing in a photographing optical system, and the reference position corresponds to an infinity focus position of the photographing optical system.

11. The lens driving apparatus according to claim 10, wherein the reference position detector is a photo-interrupter, and the driving position output unit is a Giant Magneto-Resistance (GMR) sensor.

12. The lens driving apparatus according to claim 8, wherein the locking unit comprises:
a restriction member provided in the stationary member; and
a second driving unit configured to drive the restriction member at a position abutting on the lens holder and at a position away from the lens holder.

13. The lens driving apparatus according to claim 12, wherein the second driving unit includes a step motor, and a gear array that transfers rotation of the step motor.
